(19) United States
(12) Patent Application Publication
(10) Pub. No.: US 2026/0318425 A1
(43) Pub. Date: Oct. 15, 2026

(54) CONTROL VALVE HAVING SWITCHABLE CONTROL EDGE

(71) Applicant: Moog GmbH, Böblingen (DE)

(72) Inventor: Thorsten Matthias Koehler, Deisslingen (DE)

(21) Appl. No.: 19/483,455

(22) PCT Filed: Apr. 25, 2024
(86) PCT No.: PCT/EP2024/061383

§ 371 Date: Nov. 11, 2025

(30) Foreign Application Priority Data
May 19, 2023 (DE) 102023113212.1

(51) Int. Cl. F16K 11/07; B29C 45/23; F15B 13/04; F16K 31/122

(52) U.S. Cl. CPC F16K 11/07; B29C 45/23; F15B 13/0401; F16K 31/1221

(57) ABSTRACT

The invention relates to a control valve having a switchable control edge, and comprising a valve body (1) having a first control slide (400) and at least two control terminals (501; 502; 503; 504; 505) and at least one control edge (6; 44; 45), wherein the first control slide (400) has an axial bore (40) and a second control slide (41) is formed in the axial bore (40); and further comprising an end cap (57) having an actuating piston (48), wherein the actuating piston (48) is designed to engage in the axial bore (40), and the actuating piston (48) is designed to move the second control slide (41) in the axial bore (40).

The subject matter of the invention concerns the integration of an adjusting mechanism into an existing control valve, which firstly allows a small relative overlap between the control edges P-A and A-T of a control valve during normal operation, and secondly in a standstill situation (failsafe situation) separates the A port from the T port.

In applications that utilize hydraulically pilot-controlled 4/3 directional control valves of longitudinal-slide piston design (plate-type valve construction), there is a demand to prevent a movement of the spindle, for example, of an injection unit of a plastics injection molding machine, which is controlled by means of the control valve, in the standstill situation (failsafe situation). What is critical here is in particular a deploying movement of the injection cylinder, which must imperatively be avoided.

This is generally achieved in that the P control edges for the connection of the pressure supply are, in the failsafe situation, covered sufficiently to prevent or at least minimize a fluid volume flow into the consumer.

To now prevent a retraction movement of the injection cylinder, an A-T control edge from the consumer, for example the injection unit, must also be covered in order to prevent a fluid volume flow to the tank. External forces acting on the spindle can thus be prevented from causing an undesired movement thereof. Here, slide-type valves always exhibit inherent gap leakage.

The failsafe situation constitutes a safe machine state in which the control valve is not being actively electronically controlled—that is to say it has generally been switched into a current-free and voltage-free state, and the control slide is not being actively controlled in terms of its position. In the failsafe situation, the control slide is brought into an end position or defined position by means of mechanical failsafe mechanisms, for example springs and/or end stops, and switching valves.

On the other hand, during (normal) operation, the least possible overlap at the P-A control edge and A-T control edge of the control valve is required in order to be able to carry out precise spindle position/pressure or force control.

A problem here is that the two requirements conflict with one another. Either the control slide is manufactured with a small overlap or even zero overlap of the control edges P-A and A-T, which allows precise control but results in a retracting drift movement of the spindle of an injection machine in the failsafe situation (because then the A-T control edge already exhibits undercoverage), or the control slide is manufactured with overlapping control edges, for example the P-A and A-T control edges, which results in imprecise control, but in return ensures that the spindle is at a standstill, or ensures a sufficiently small movement of the spindle, in the standstill situation (failsafe situation).

Overlapping control slides are known which, during active control, are electronically compensated, which is known as dead band compensation, but this reaches its limits under dynamic conditions. Ultimately, for the control of a pressure or volume flow in a working port, the physical overlap of the control edges must always be passed through, which, depending on the size of the overlap at the control slide (dead band to be passed through) and the dynamics of the pilot control valve, can be detrimental to the control result because a certain amount of time is required to pass through the region of overlap.

It is also known for safety valves, generally seat valves, to be connected in series with the control valve in order to decouple the consumer ports or the pressure supply from the control valve. Seat valves additionally connected in series take up structural space. Said seat valves must be of correspondingly large dimensions because they must be adapted to the maximum volume flow of the control valve. In general, they are selected to be one nominal size larger in order to minimize the pressure losses and thus energy losses during operation. A disadvantage is that, depending on the switching dynamics of the control valve, seals of the seat valve can be subjected to high loads, which increases maintenance costs and times. Additional seat valves also constitute a further cost factor.

Another known approach is to use separate control valves in order to control/regulate the two ports of the actuator separately from one another. Accordingly, an individual failsafe position may be set for each of the separate control valves, as required by the application—the disadvantage of this solution is that two or more control valves are required, making the solution expensive. The actuation for control purposes is also more complex.

Proceeding from the known prior art, it is an object of the present invention to provide a control valve having a control edge, which at least partially overcomes the disadvantages that exist in the prior art.

In particular, it is an object to integrate an adjusting mechanism into an existing control valve, which firstly allows a small relative overlap between the control edges P-A and A-T during (normal) operation, such that precise control is made possible, and secondly in a standstill situation (failsafe situation, in which the A port has already been separated from the pressure supply P by an overlapped P-A edge) additionally separates the A port from the T port, that is to say exhibits an overlap sufficient to ensure that the spindle is at a standstill or to ensure a sufficiently small spindle movement.

Said object is achieved by the subjects of the independent patent claims. Advantageous embodiments of the invention are described in the dependent patent claims and in the following description.

A control valve having a switchable control edge may comprise a valve body and an end cap having an actuating piston. The valve body may be formed with a first control slide and at least one first and second control port and at least one control edge. Here, the first control slide may have an axial bore, and a second control slide may be formed in the axial bore.

A control valve may be a valve, in particular a hydraulic valve, which influences the pressure liquid in terms of the flow path, direction and magnitude of the volume flow or the liquid pressure. According to the disclosure, said control valve is a directional valve having the structure and design of the effective surface (sealing surface) of a slide valve, together with the movement action of a longitudinal valve.

A control edge may be a movable edge in a valve, which edge controls the flow of liquids or gases between the ports on the valve. Said control edge is actuated by a force, for example a lever or an electrical and/or pneumatic drive, and acts by opening or closing a flow channel between two control ports in the valve body. In particular, the movable edge is a surface of the first and/or second control slide, which surface can cover an opening of a flow channel of a control port and/or a plurality of control ports of the valve body and thus partially or fully opens up and/or shuts off a passage or flow path between control ports. According to the invention, the valve body and the control slide form mutually coordinated control edges which are movable coaxially with respect to one another, such that, when the respective openings of the control ports in the valve body are situated opposite one another, a flow path is created and/or throttling occurs. A control valve according to the disclosure may comprise at least three control edges.

A first control edge may be a control edge of piston longitudinal slide design, such as is known from hydraulically pilot-controlled 4/3 directional valves, which controls the flow between the control ports A and T. A first control edge may be a first A-T control edge, which can also be referred to as A-T1 control edge.

A second control edge may be a novel control edge according to the disclosure, which additionally to the first control edge controls the flow between the control ports A and T.

The second control edge may be a second A-T control edge, which can also be referred to as A-T2 control edge.

According to the invention, the third control edge corresponds to a first control edge and, by means of an axial movement of the first control slide, can be actuated such that the third control edge partially to fully opens up and/or correspondingly partially to fully closes the single passage between the control ports P and A. The flow between two control ports P and A can thus be controlled. A third control edge may also be referred to as P-A control edge.

A fourth control edge may be a control edge that controls the flow between the control ports P and B. The fourth control edge may be referred to as P-B control edge.

A fifth control edge may be a control edge that controls the flow between the control ports B and T. The fifth control edge may be referred to as B-T control edge.

A control edge may be switchable. A switchable control edge can open up and/or shut off the flow paths between the control ports by virtue of the first and/or second control slide being actuated and adjusted. According to the disclosure, this may be performed by means of an electrical, pneumatic or hydraulic and/or piezoelectric or magnetostrictive drive. A switchable control edge can allow a fast reaction to changes in the system and precise control of the flow of liquids or gases by virtue of the fact that it can be precisely switched from one position into another position and, in the active position, makes it possible to provide zero overlap between the control edges P-A and A-T.

A control port of a control valve according to the disclosure may be a port in the valve body. The control port may open into an annular channel in the valve body. For example, the line of a pressure supply X of a pilot control valve and/or the return line Y to the tank and/or the pressure supply P of the valve body and/or a further return line T to the tank and/or at least one working port A, B may be connected to a control port.

A first control port may be a T control port. A second control port may be an A control port. A third control port may be a P control port. A fourth control port may be a B control port. A B-side T channel may be a chamber which, to the right of the B control port in a longitudinal section of the valve body, is connected via a channel, in particular a tank bridge, to the first control port. Said channel may be a B-side T channel.

A first and a second control slide according to the disclosure may be a hydraulic control slide. The control slides may be used in directional valves of slide valve type. The second control slide may, according to the disclosure, be formed within the first control slide.

The actuating direction of the two control slides extends coaxially along the longitudinal axes thereof, such that the respective control edges of the control slides fully overlap, partially overlap and/or do not at all overlap the openings of the control ports in the valve body, depending on the position of the control slide being moved.

The first and the second control slide may each comprise at least two piston shoulders relative to the piston shaft, said piston shoulders forming the control edges on the control slide. The first control slide may form a first and a second piston shoulder. The first control slide may also form a third piston shoulder. The first control slide may also form a fourth piston shoulder. The second control slide may also form a first and a second piston shoulder. Depending on the position of the first and/or the second control slide, the piston shoulders may cover control port openings in the valve body and thus regulate the flow between the control ports. The piston shoulders of the control slides may be arranged in a port region of the control ports. A piston shoulder of a control slide, which depending on position covers a control port opening, may form a control edge together with said opening in the valve body.

An axial bore is a bore in the valve body and in the first control slide along a longitudinal axis of the first control slide, such that the first control slide is received movably in the bore of the valve body and the second control slide is received movably in the bore of the first control slide. The bore may be centered in the control slide.

Furthermore, according to the disclosure, the control valve having a switchable control edge may have an end cap having an actuating piston. In this case, the actuating piston may be designed to engage into the axial bore and also designed to move the second control slide in the axial bore of the first control slide.

A second control edge between the control ports T and A can thus be actuated. The second control edge can have the effect that the disclosed control valve combines the functionality of two valves. Firstly, when failsafe valves are activated, zero overlap behavior and thus good controllability of the spindle connected to the valve can be ensured, and secondly, when failsafe valves are deactivated, leakage can be reduced to a minimum, which may correspond to gap leakage. A second, series-connected (seat) valve can be rendered superfluous. This can lead to savings in terms of costs, servicing/maintenance and structural space. Furthermore, said component does not need to be stocked as a replacement part. According to the disclosure, an otherwise conventional series-connected (downstream) second (seat) valve, which can give rise to a (constant) pressure loss, can be omitted. A control valve system having the control valve according to the disclosure can be more energy-efficient than the combination, known from the prior art, of control valve and series-connected (seat) valve.

A connecting element may be formed between the actuating piston and the second control slide. Axial and angular offsets can thus be compensated for.

A connecting element may comprise a compensating rod and at least two locknuts. A first locknut can be locked together with the second control slide. A second locknut can be secured to an actuating piston. The second locknut may be formed as a mechanical stop and hardened. The connecting element between the actuating piston and second control slide may perform a coupling function and may therefore be a coupling element.

A manufacturing-induced axial offset of the actuating piston and the second control slide that moves within the first control slide can thus be compensated for.

Furthermore, the valve body and the first control slide of the control valve may form a first (A-T1) and a second control edge (A-T2). Here, a small relative overlap may be formed between the second control edge (A-T2) and a third control edge (P-A). The first control edge (A-T1) may exhibit a sufficient overlap.

The second control slide may also be designed so as to actuate, that is to say open or close, the second control edge (A-T2) independently of the first control slide. Thus, according to the disclosure, a precise adjusting mechanism can be integrated, by way of the second control edge (A-T2), into the control valve. At the same time, in the standstill situation (failsafe situation), a flow path from one control port to the next control port can be prevented by virtue of the first control edge (A-T1) exhibiting a sufficient overlap, and a retracting drift movement of a spindle, for example of an injection molding machine, can thus be prevented.

A flow path may be formed between at least two control ports and influenced by a control edge such that the flow rate can be controlled.

According to the disclosure, an overlap may be a positive overlap, a zero overlap or a negative overlap. Positive overlap may describe the control edge length of a piston shoulder of the first and/or second control slide, the length of which is greater than the width of the opening of the annular channel of the control ports in the housing of the valve body.

The overlap relates to the total stroke of the first and/or second control slide in the central position or end position and can be stated in percent [%].

Zero overlap can be characterized by the flush positioning of the control edges of the piston shoulders of each of the two control slides and of the annular channels of the control ports in the housing of the valve body. Zero overlap of control edges can result in very short adjustment or response times at the actuator connected to the control valve, because the opening cross section of the annular channel of the respective control ports in the valve body is opened up without a delay, and only small actuating travels are required for modulation and control.

Negative overlap may describe the control edge length of a piston shoulder of the particular control slide, the length of which is smaller than the width of the annular channel of the control ports in the housing of the valve body. Negative overlap may be undercoverage.

A small overlap may be present if the overlap of an individual control edge lies between 0% and 5%. A small overlap of 0% may be zero overlap.

A relative overlap may be the ratio between two overlaps. For example, a sum of the overlap of one control edge and the overlap of a further control edge may be calculated. This sum can yield a relative overlap.

The relative overlap may be a small relative overlap if the sum lies between 0% and 10%. The second control edge (A-T2) may form such a small relative overlap with the third control edge (P-A).

A large overlap of an individual control edge may amount to 10% and more. A sufficient overlap and/or a sufficiently large overlap may lie between 10% and 20%. The first control edge (A-T1) may exhibit such a large overlap and/or sufficient overlap. The third control edge (P-A) may also exhibit a large overlap. A large and/or sufficiently large overlap ensures the stoppage, or a sufficiently small movement, of a spindle/an actuator, for example of an injection unit, in the failsafe situation. The P-A control edge (third control edge) may exhibit a large overlap.

According to the invention, a negative overlap and/or undercoverage of an individual control edge is less than 0%. The fifth control edge (B-T control edge) may exhibit such undercoverage.

The second control edge (A-T2 control edge) may have a notch-like annular channel. The notch-like annular channel may be formed into the piston shoulder. The second control edge may instead, and/or in addition, have one or more control windows distributed over the circumference.

The notch-like annular channel and the one or more control windows are each formed at the inlet and outlet of a transverse bore of the first control slide. Both may have different shapes. For example, the notch-like annular channel may have a rectangular cross section or a cross section with rounded corners at the base. In the case of control windows, these may also have different cross-sectional shapes, for example rectangular, triangular, circular or T-shaped.

The annular channel and the one or more control windows may be axially exactly adapted in terms of manufacturing to the third control edge (A-T2) in the valve body on an application-specific basis, in particular to the third control edge (P-A). The second control edge (A-T2) can thus allow precise control. Furthermore, the second control edge (A-T2) according to the disclosure may, in the failsafe situation, separate the control port A from the control port T, because the second control edge (switchable by means of the inner second control slide) and the first control edge (A-T1) can, together, be moved into a position such that, viewed from the outside, a sufficient overlap can be achieved at the first (A-T1), second (A-T2) and third (P-A) in order to ensure that the spindle is at a standstill, or to ensure a sufficiently small movement of the spindle.

The annular groove or the one or more control windows of the second control edge (A-T2) may be connected via at least one first transverse bore to the axial bore in the first control slide.

The first transverse bore may be formed in a first piston shoulder of a plurality of piston shoulders of the first control slide. The first piston shoulder may have a plurality of first transverse bores. The first transverse bore(s) may be perpendicular to the longitudinal axis of the axial bore of the first control slide. The first piston shoulder of the first control slide is formed furthest to the left as seen in a longitudinal section through the valve body of the control valve. The second control edge (A-T2) may be arranged in the first piston shoulder.

The second control edge (A-T2) may be formed in the first piston shoulder by means of the first transverse bore(s). The first transverse bore(s) can have the effect that the disclosed control valve combines the functionality of two valves. Firstly, when failsafe valves are activated, zero overlap behavior and thus good controllability of the spindle connected to the valve can be ensured, and secondly, when failsafe valves are deactivated, leakage can be reduced to a minimum, which may correspond to gap leakage. A second, series-connected (seat) valve can be rendered superfluous. This can lead to savings in terms of costs, servicing/maintenance and structural space. Furthermore, said component does not need to be stocked as a replacement part.

According to the disclosure, an otherwise conventional series-connected (downstream) second (seat) valve, which can give rise to a pressure loss or constant pressure loss, can be omitted. A control valve system having the control valve according to the disclosure can be more energy-efficient than the combination, known from the prior art, of control valve and series-connected (seat) valve.

The first control slide may form at least one second transverse bore in the port region of a second control port (A) of the valve body. Additionally, the at least one second transverse bore may be connected to the axial bore of the first control slide.

A port region may be a part of the valve body through which liquids or gases can be caused to flow in or out. Port regions may be formed on the outside of the valve body, and have a defined port diameter in order to allow a fixed connection to control blocks, pipes, tanks or other system components. The ports may assume different forms, including threads, flanges or plug-in ports. The port region may be designed such that the port region extends into the valve body.

This can have the effect that the second control edge (A-T2) in the first piston shoulder of the first control slide is connected via the axial bore to the second transverse bore. The second transverse bore may form a flow inlet in a second piston shoulder of the first control slide, though may alternatively also form a further control edge with respect to the second control slide (which is part of an inner system of the first control slide). This alternative further control edge may, in terms of its function, adjust the flow between the control ports A and T via the second control edge (A-T2).

According to the disclosure, the actuating piston may be designed to control, by means of the second control slide, a flow path via the second control edge (A-T2).

The expression “via the second control edge” may mean that the flow path from one control port to another control port is opened up. For this purpose, the axial movement of the first and/or second control slide may have the effect that the corresponding control edge opens up the flow path between two control ports and thus regulates the flow rate.

This can lead to precise control of the disclosed control valve, because a relatively small relative overlap between the second control edge (A-T2) and the third control edge (P-A) is realized during normal operation. By contrast, in the failsafe situation, the control port A can be separated from the control port T by virtue of the first control edge (A-T) and the third control edge (P-A) achieving a sufficiently large overlap, thus making it possible to ensure that the spindle is at a standstill or to ensure a sufficiently small spindle movement.

For hydraulic compensation, the second control slide may have two surfaces with effective surfaces of equal size.

The surfaces may be ring-shaped or circular. The surfaces may each be formed on a piston shoulder of the second control slide.

A load pressure prevailing at the second control port (A) therefore cannot cause undesired actuation of the second control slide. This can in turn allow precise control of the control valve according to the disclosure. In the failsafe situation, the second control port (A) can be separated from the first control port (T) by virtue of the first control edge (A-T1) and the second control edge (P-A) achieving a sufficiently large overlap, thus making it possible to ensure that the spindle is at a standstill, or to ensure a sufficiently small spindle movement, in the failsafe situation.

According to the disclosure, the axial bore of the first control slide may comprise a chamber having an inner compression spring.

As seen in a longitudinal section of the valve body, the chamber may be formed as an elongation of the right-hand end of the axial bore. A rear part of the axial bore may comprise the chamber. The chamber may be formed in the first control slide at a level between a second and a third piston shoulder of the first control slide. The chamber may be formed at the level of the third port (P).

Said chamber can serve to receive a spring and, in an end position of the first and/or second control slide, to form a stop for the second control slide. This can allow precise control of the control valve of the disclosure. In the failsafe situation, the control port A can be separated from the control port T by virtue of the first control edge (A-T1) and the second control edge (P-A) achieving a sufficiently large overlap, thus making it possible to ensure that the spindle is at a standstill or to ensure a sufficiently small spindle movement.

According to the disclosure, an axial relief bore may be formed coaxially with respect to the axial bore. Here, the first control slide may have, in the region of the B-side T channel, at least one third transverse bore which is connected to the axial relief bore. The B-side T channel and the third transverse bore may form a leakage flow path.

The third transverse bore according to the disclosure may be perpendicular to the axial relief bore. The third transverse bore may discharge the leakage from the inner system (the chamber of the axial bore of the first control slide).

This can allow precise control and actuation of the control valve, and additionally, in the standstill situation (failsafe situation), a flow from one control port (A) to the next control port (T) can be prevented by virtue of the first control edge (A-T1) exhibiting sufficient overlap. Together with the third control edge (P-A), which in the failsafe situation exhibits an overlap, this can ensure that a spindle is at a standstill, or can ensure a sufficiently small spindle movement.

The second control slide may form a slot on its right-hand end face. Said slot may discharge leakage.

The right-hand end face may be formed in a second end region of the second control slide. A left-hand end face of the second control slide may be formed in a first end region of the second control slide. The left-hand end face and the right-hand end face may be formed at opposite end regions of the second control slide.

The slot can, in the blocked state, allow leakage from the chamber to be discharged from the axial bore. This prevents a pressure from being able to build up in the chamber of the first control slide as a result of leakage volume flows, thus preventing undesired opening of the second control slide. The disclosed control valve can thus make a precise adjusting mechanism possible, and in the failsafe situation can separate the second control port (A) from the first control port (T). In this case, the leakage can be discharged via the slot, and it can nevertheless be ensured that a spindle is at a standstill.

The end cap may comprise a valve and a spring chamber. The spring chamber may comprise a compression spring and a stop.

As seen in a longitudinal section of the valve body, the spring chamber and the end cap may be attached to a first end of the valve body on the left-hand side. Depending on the application, the end cap and the spring chamber may also be attached to the valve body of the disclosed control valve on the right-hand side.

The end cap can, by means of the actuating piston, make it possible to realize a precise adjusting mechanism in the disclosed control valve. Owing to the precise control, it is possible in the failsafe situation for the second control port (A) to be separated from the first control port (T) by virtue of the first control edge (A-T1) and the third control edge (P-A) achieving a sufficient overlap, in order to ensure that the spindle is at a standstill, or to ensure a sufficiently small spindle movement.

The spring chamber of the disclosure may be connected to the valve body via a relief bore.

The relief bore may lead out of the spring chamber and end at the valve body, in which the relief bore may be continued further. One complete passage can thus be formed, allowing a flow path in the direction of a tank via the T control port.

The spring chamber can thus be constantly relieved of pressure in the direction of the tank, and the precise control of the control valve can be ensured.

The control valve of the disclosure can be used as an injection control valve for controlling an injection unit of an injection molding machine.

During normal operation, precise control of the injection molding machine can be made possible, and in the failsafe situation, it is possible to achieve a safe machine state of the injection molding machine, in particular that a spindle is at a standstill.

A control valve system may comprise a pilot control valve, one or two failsafe valve(s), and a control valve of the disclosure. A failsafe valve may be a safety valve.

The advantage is that, both in normal operation, a relatively small overlap between the second (A-T2) and third (P-A) control edges is made possible, which leads to precise control and, secondly, in the failsafe situation, separates the A port from the T port, that is to say the first control edge (A-T1) and third control edge (P-A) exhibit a sufficient overlap, thus allowing a safe machine state of the control valve system in the failsafe situation.

When failsafe valves are activated, the control valve system can ensure precise controllability of the spindle of the injection molding machine. When failsafe valves are deactivated, the control valve system can reduce leakage to a minimum, which may correspond to gap leakage, and can ensure that a spindle is at a standstill, or can ensure a sufficiently small spindle movement, in the failsafe situation. The control valve system having the control valve according to the disclosure can be more energy-efficient than the control valves known from the prior art.

The above embodiments and refinements may be combined with one another as desired where appropriate. Further possible embodiments, refinements and implementations of the invention also comprise combinations, which have not explicitly been mentioned, of features of the invention which have been described above or below with regard to the exemplary embodiments. In particular, a person skilled in the art will also add individual aspects as improvements or enhancements to the particular basic form of the present invention.

The present invention will be discussed in more detail below on the basis of the exemplary embodiments shown in the schematic figures of the drawings. In the drawings:

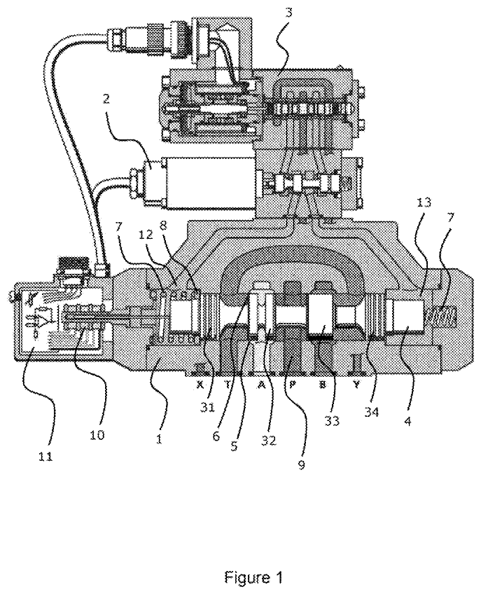

FIG. 1 shows a control valve according to the prior art

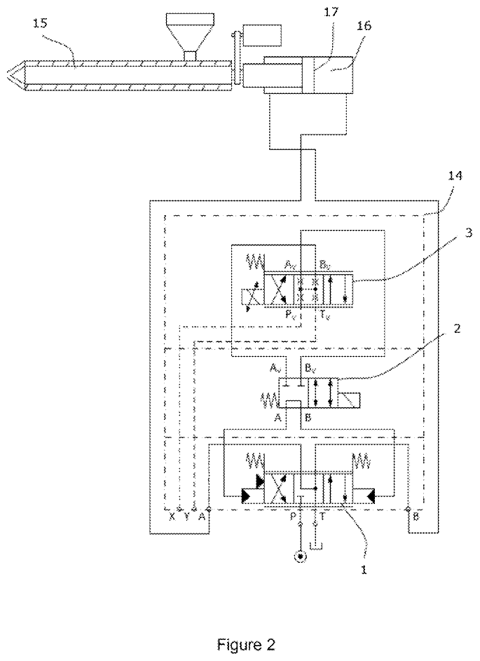

FIG. 2 shows a usage example in the prior art

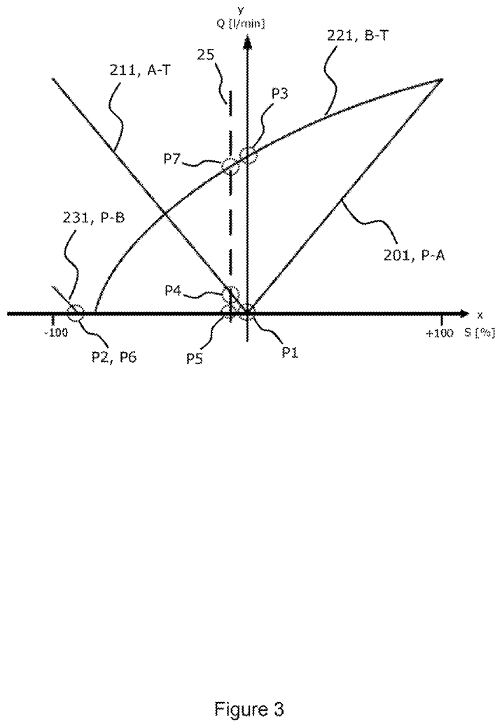

FIG. 3 shows a volume flow-signal function of a control valve in the prior art

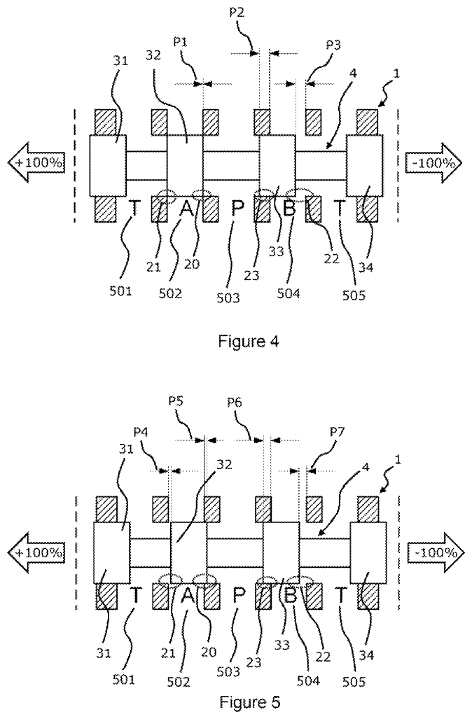

FIG. 4 is a schematic illustration of a control valve during normal operation in the prior art with zero overlap

FIG. 5 is a schematic illustration of a control valve in a failsafe position in the prior art with overlap and undercoverage

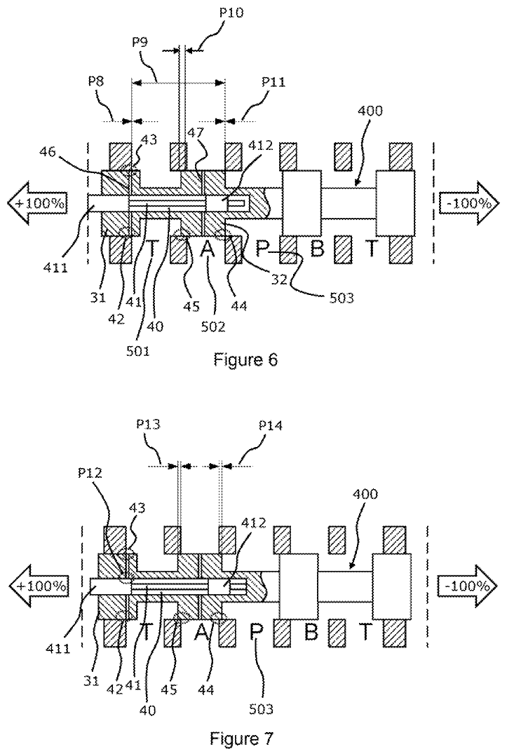

FIG. 6 is a schematic illustration of the control valve according to the disclosure during normal operation with an opened second control slide

FIG. 7 is a schematic illustration of the control valve according to the disclosure in a failsafe position with a closed second control slide

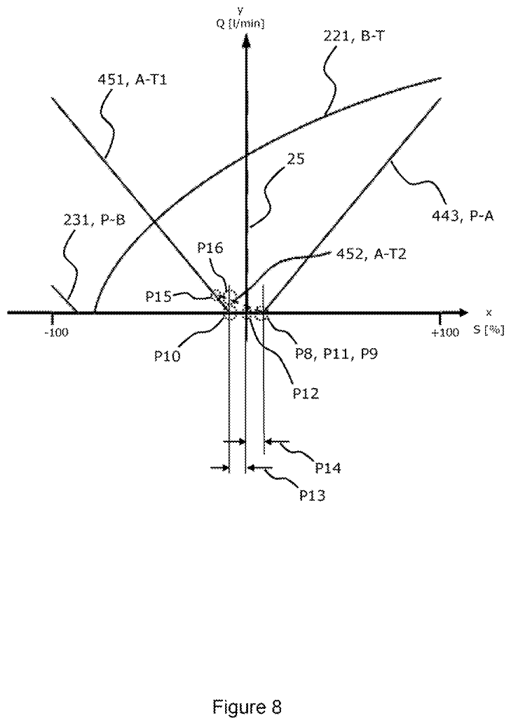

FIG. 8 shows a volume flow-signal function of a control valve according to the disclosure

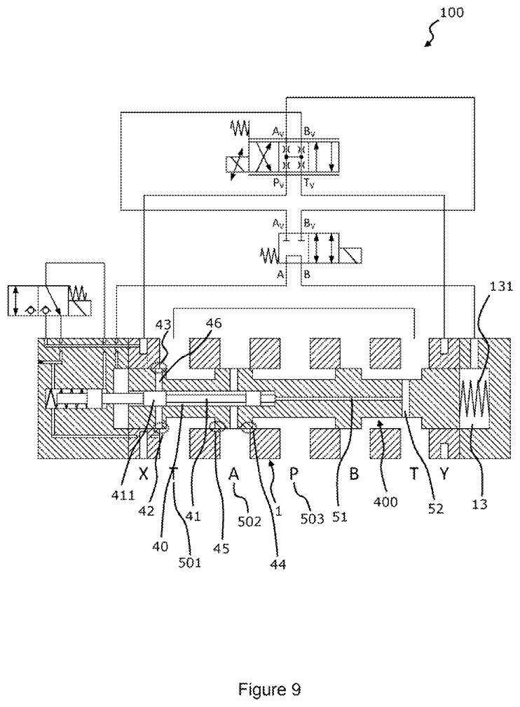

FIG. 9 is a schematic illustration of the control valve according to the disclosure in a failsafe position with a closed second control slide

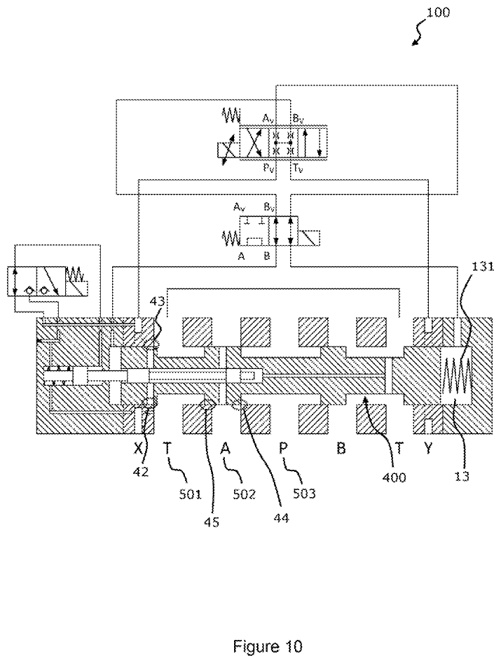

FIG. 10 is a schematic illustration of the control valve according to the disclosure during control

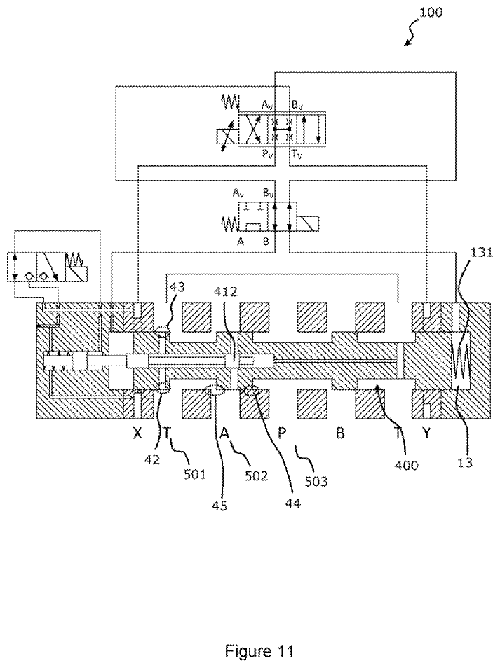

FIG. 11 is a schematic illustration of the control valve according to the disclosure in a controlled negative end position

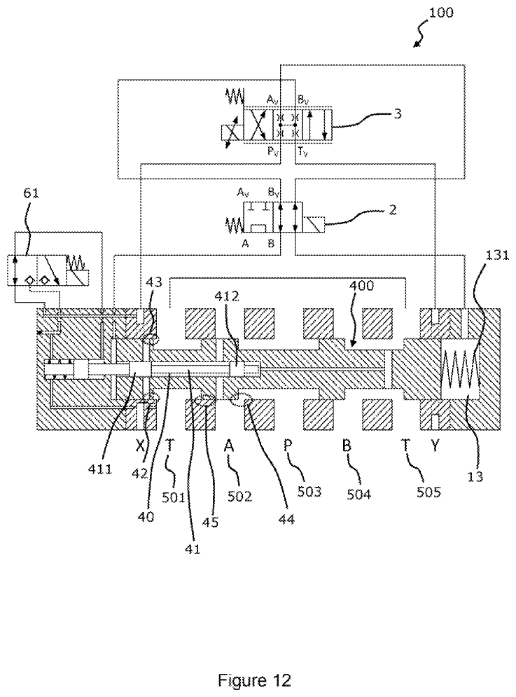

FIG. 12 is a schematic illustration of the control valve according to the disclosure in a controlled positive end position

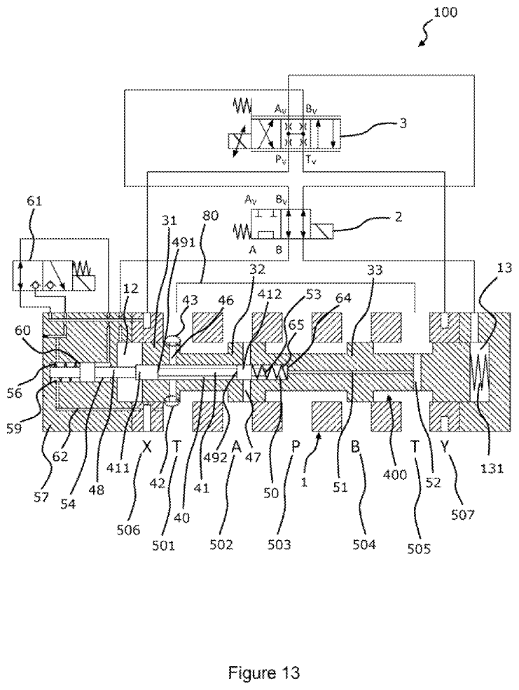

FIG. 13 shows an alternative control valve according to the disclosure in a controlled negative end position

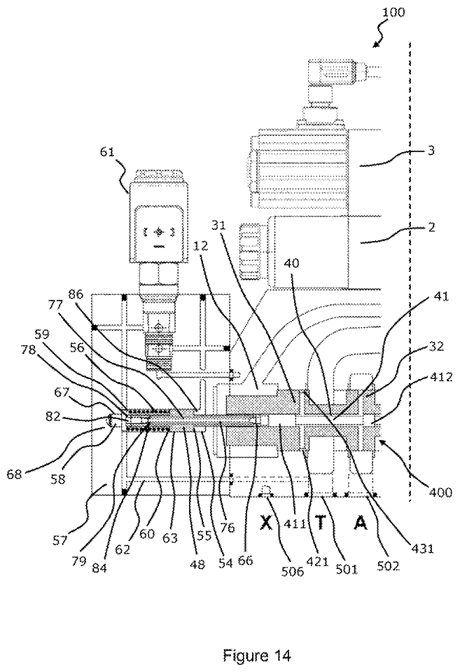

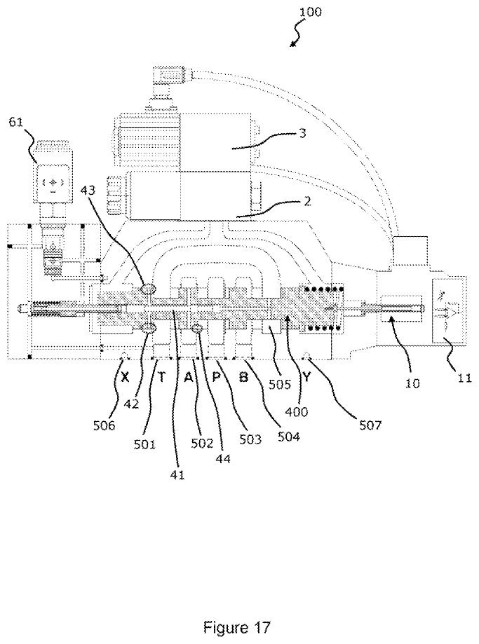

FIG. 14 shows a schematic detail illustration of the left-hand end cap of the control valve from FIG. 17 according to the disclosure

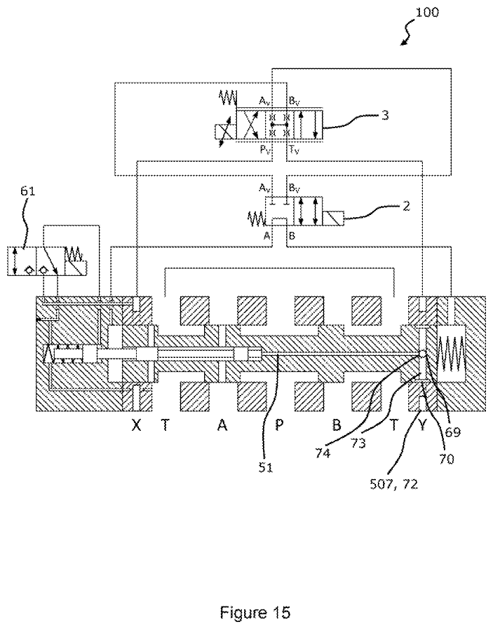

FIG. 15 is a further schematic illustration of the control valve in the failsafe situation

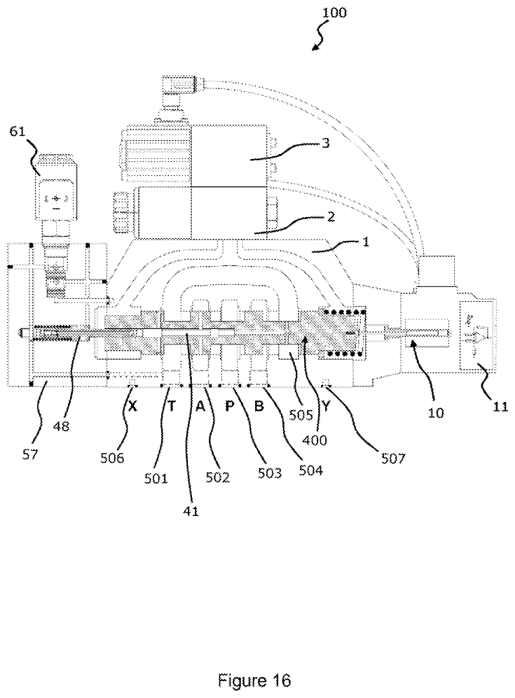

FIG. 16 is a schematic illustration of the control valve system according to the disclosure, having valve electronics and a position measuring system, in a failsafe position with a closed second control slide

FIG. 17 is a schematic illustration of the control valve system according to the disclosure, having valve electronics and a position measuring system, during control

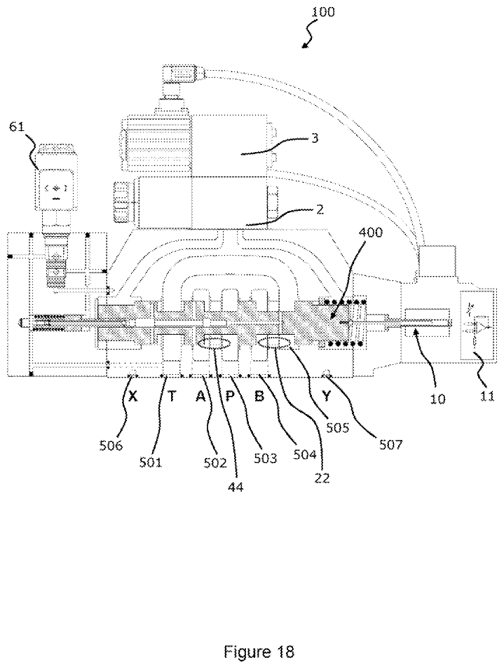

FIG. 18 is a schematic illustration of the control valve system according to the disclosure, having valve electronics and a position measuring system, in a controlled positive end position

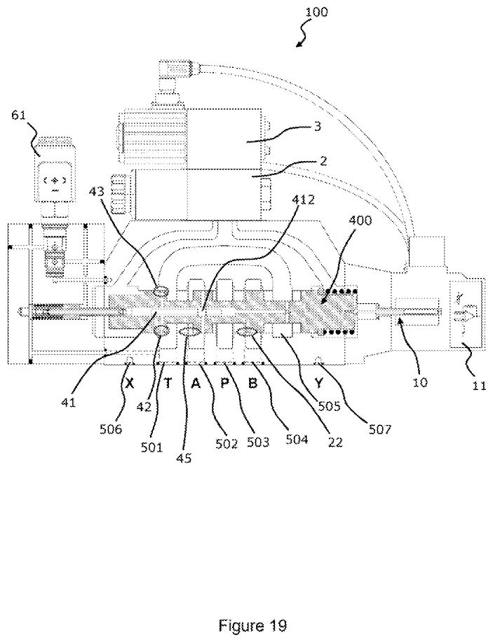

FIG. 19 is a schematic illustration of the control valve system according to the disclosure, having valve electronics and a position measuring system

The appended drawings are intended to impart further understanding of the embodiments of the invention. They illustrate embodiments and, in conjunction with the description, serve for the explanation of principles and concepts of the invention. Other embodiments, and many of the stated advantages, will become apparent in view of the drawings. The elements in the drawings are not necessarily shown true to scale relative to one another.

Unless stated otherwise, elements, features and components which are identical, functionally identical or of identical action are denoted in the figures of the drawing by the same reference signs in each case. In particular, FIGS. 6 to 14 build on one another, and therefore, for the sake of clarity, unless stated otherwise, elements, features and components of identical action are not denoted by reference signs throughout. A person skilled in the art will however recognize the presence of elements, features and components of identical action, and can add the corresponding reference signs from the preceding figure.

Finally, it is pointed out that the description of the invention and the exemplary embodiments are basically not to be understood as being limiting with regard to a particular physical implementation of the invention. All features discussed and shown in conjunction with individual embodiments of the invention may be provided in different combinations in the subject matter according to the invention in order to implement their advantageous effects simultaneously.

The scope of protection of the present invention is defined by the claims, and is not limited by the features discussed in the description and/or shown in the figures.

FIG. 1 shows the schematic structure of a pilot-controlled 4/3 directional control valve that is known in the prior art. It consists of a valve body 1, also referred to as main stage, an optional failsafe valve 2, also referred to as a safety valve, and a pilot control valve 3. A movable control slide 4 is accommodated in the valve body 1. The control slide 4 in FIG. 1 forms four piston shoulders. A first piston shoulder 31, a second piston shoulder 32, a third piston shoulder 33 and a fourth piston shoulder 34. The valve body 1 and the piston shoulders 31, 32, 33, 34 of the control slide 4 in FIG. 1 have mutually coordinated control edges, for example the control edges 5 and 6 between the control ports T and A. Here, the valve body 1 forms a fixed control edge 5 and the second piston shoulder 32 of the control slide 4 forms a movable control edge 6, because the control slide is arranged movably in the valve body 1. Depending on the position of the control slide 4 within the valve body 1, the second piston shoulder 32 opens up a flow path between the control ports T and A and between A and P.

When the failsafe valve 2 is deactivated, the control slide 4 is pushed by compression springs 7 and a mechanical stop, illustrated in FIG. 1 by adjustable disks 8 in the control chambers 12, 13, into a specified central position and, by means of the piston shoulders 31-34, closes corresponding control ports 9 (T, A, P, B) of the valve body 1.

The valve body 1 has the following control ports 9:
X—pressure supply of the pilot control valve 3 and is optional
Y—return or tank port of pilot control valve 3, also optional
P—pressure supply of the valve body 1
T—return or tank port of valve body 1
A and B—working ports to which the consumer, for example the injection cylinder 16 of an injection unit 15 of an injection molding machine, is connected.

Attached to the left-hand side of the valve body 1 is an end cap having electronics for controlling the control chambers 12 and 13. The end cap comprises a position measuring system 10 and valve electronics 11. The position of the control slide 4 is measured by means of the position measuring system 10 and is controlled by valve electronics 11.

The pilot control valve 3 supplies a volume flow and pressure to the left-hand control chamber 12 and the right-hand control chamber 13 of the valve body 1. Depending on the electrical actuation of the pilot control valve 3, the control valve 4 is deflected to the left or to the right from the central position and thus opens up corresponding flow paths P-A and B-T or P-B and A-T respectively.

FIG. 2 is a schematic illustration of an injection unit 15 having a control valve which is an injection control valve 14. In this usage example of the invention, the control valve 14 controls the injection unit 15 of an injection molding machine. If the protective grille of the machine is opened, the failsafe situation takes effect, and the control valve must be transferred into a safe state. In no case should the injection cylinder 16 advance and thus deploy the injection unit 15. This means that the working port of the control valve which is connected to that cylinder chamber/surface 17 of the injection cylinder 16 which enables the injection movement must not in any case be pressurized.

During the plasticizing of the plastics melt or during setup operation, the plastics melt situated in the injection cylinder exerts an external force that causes a movement of said injection cylinder oppositely to the injection movement. In certain applications, or in particular during setup operation when protective doors are open, this movement is undesired for process-related reasons. To prevent this movement, the volume flow that can flow back from the spindle via the control valve into the tank must be shut off/reduced to a sufficiently low flow rate.

Injection control valves are often designed to control/regulate the volume flow or pressure on that side of the piston of the injection cylinder which is connected for example to the A control port 502 of the control valve 1. An injection cycle is divided into the following phases, and is illustrated by way of example in the volume flow-signal function in FIG. 3:
“injection” (via the P-A control edge 20)
“pressure control” with decompression phase (via the P-A control edge 20 and A-T control edge 21)
“plasticizing” (replenishment via the B-T control edge 22)
“retraction movement” of the injection cylinder (via the P-B control edge 23 and A-T control edge 21)

Of importance for the process is the pressure control with decompression phase. This is significantly influenced by the geometrical coordination of the P-A control edge 20 and A-T control edge 21.

The geometry of the control slide 4 in FIG. 1, that is to say the overlap of the individual control edges and resulting volume flow-signal function, is adapted to each application.

The geometry for the 4/3 directional control valve from FIG. 1, in particular the overlap of the control edges, is schematically illustrated in FIGS. 4 and 5 on the basis of P1 to P7. The corresponding prevailing volume flow is schematically illustrated in the characteristic curves 201, 211, 221, 231, of the control edges 20, 21, 22, 23 in FIG. 3 correspondingly at P1 to P7. FIG. 4 shows a control slide 4 from the prior art during normal operation with zero overlap P1 of the control edges 20, 21, which allows good controllability. FIG. 5 shows the same control slide 4 from the prior art, but in a failsafe position. In relation to the position in FIG. 4, the control slide 4 has been shifted to the right, such that the P-A control edge 20 exhibits an overlap P5, but as a result the A-T control edge 21 has moved into a position of undercoverage P4, and the passage between the T and A control ports 501, 502 remains open. This is undesired in the failsafe position 25, and is prevented by means of the switchable control edge according to the disclosure (FIGS. 6 to 14). Owing to the position of undercoverage P4 on the characteristic curve 211, a volume flow prevails at the A-T control edge 21, as illustrated in FIG. 3, and owing to the position of overlap P5 on the x axis and failsafe position 25 in FIG. 3, no volume flow prevails at the P-A control edge 20.

During normal operation in FIG. 4, the P-A control edge 20 exhibits a relatively small relative overlap between the P and A control ports 502, 503 together with the A-T control edge 21 between the A and T control ports 502, 501. In particular, in FIG. 4, the control edges 20, 21 are configured with zero overlap P1, for which reason the small relative overlap from the two zero overlaps from the control edge 20, 21 results in turn in a zero overlap. The B-T control edge 22 between the B control port and the B-side T channel 505 exhibits extensive undercoverage, see P3 in FIGS. 3, 4, and the P-B control edge 23 between the P and B control ports 503, 504 exhibits extensive overlap, see also P2 in FIGS. 3, 4. As illustrated by P2, in FIGS. 3 and 4, the P-B control edge 23 exhibits an overlap, and it is therefore also the case that no volume flow passes between the P and B control ports 503, 504. The very small relative overlap of the P-A and A-T control edges 20, 21, which is shown in FIG. 4 by a zero overlap, is represented in FIG. 3 and FIG. 4 by P1.

The geometry of the control slide 4 in FIGS. 4, 5 can also be understood from the volume flow-signal function in FIG. 3. FIG. 3 shows a volume flow-signal function, which is known in the prior art, for the control valve and its control slide 4 from FIGS. 1, 2 and 4, 5 during normal operation. The y axis in FIG. 3 shows the volume flow Q in liters per minute (Q [l/min]), whilst the x axis represents the control slide stroke S, which corresponds to the distance covered by the control slide 4 from FIG. 1 in percent. The greater the percentage control slide stroke S, the greater the volume flow that passes through the corresponding passages of the control ports T, A, P, B, because these are opened up by the control edges 20, 21, 22, 23 as a result of a movement of the control slide 4.

In FIG. 3, −100% denotes a negative end position, which corresponds to a maximum movement of the control slide 4 to the right in the valve body 1. Accordingly, a positive end position +100% denotes a maximum deflection of the control slide 4 to the left in the valve body 1. At each maximum deflection, it is for example the case that stops at the corresponding end prevent a further deflection of the control slide 4.

FIG. 3 also shows the control slide stroke S and thus the overlap of the control edges 20, 21, 22, 23, in that the characteristic curves 201, 211, 221, 231 represent the volume flow, in particular in the failsafe situation of a control valve in the prior art. In the failsafe position 25 in the failsafe situation, when the failsafe valve 2, which in FIG. 1 is arranged between the pilot control valve 3 and valve body 1, is deactivated, the control slide 4 assumes a defined spring-centered position. This failsafe position of the control slide 4 is indicated in FIG. 3 by a dashed line 25 and is schematically illustrated in FIG. 5.

By means of corresponding adjustable mechanical stops 8 in the control chambers 12, 13, the control slide 4 in FIG. 1 assumes a position such that the P-A control edge 20 of the control slide 4 in FIG. 3 assumes a position of overlap, see the intersection point P5 on the x axis, and the failsafe position 25 illustrated using dashed lines, in FIG. 3. Consequently (owing to the very small relative overlap, or the zero overlap, of the P-A and A-T control edges 20, 21 from FIG. 4), the A-T control edge 21 assumes a position of undercoverage as seen relative to the valve body 1, see the intersection point P4 of the volume flow-signal function 211 with failsafe position 25 in FIG. 3 and FIG. 5. In the failsafe situation, the B-T control edge 22 between the B control port and the B-side T channel 505 continues to exhibit undercoverage, see P7 in FIGS. 3, 5, and the P-B control edge 23 between the P and B control ports 503, 504 continues to exhibit overlap, see also P6 in FIGS. 3, 5.

The piston surface of the injection cylinder 17 in FIG. 1 is thus no longer acted on by supply pressure. This has the effect that a deployment, for example of the injection cylinder, is avoided. At the same time, via the open A-T control edge 21, fluid can escape from the injection cylinder if this is subjected to an external force, for example during plasticizing or during setup operation, when the injection cylinder is filled with plastics melt.

As already mentioned, according to the disclosure, an adjusting mechanism is integrated into an existing control valve. For this purpose, it is sought to achieve good controllability during normal operation by means of a small relative overlap between the P-A and A-T control edges 20, 21, and in the failsafe situation also a separation of the A control port 502 from the T control port 501 and the same time from the P control port 503 by virtue of A-T and P-A control edges exhibiting an overlap.

Until now, in the prior art, the only known control valves exhibiting fast and precise control have been produced with control edges as configured in FIGS. 3, 4 and 5. That is to say control edges, ideally with a small relative overlap or zero overlap of the A-T and P-A control edges 21, 20 as shown in FIG. 3 and FIG. 4, in order to allow fast and precise control and, on the other hand, in the failsafe position 25, as shown in FIG. 3 and FIG. 5, separates the A control port 502 from the P control port 503, that is to say exhibits sufficient overlap of the P-A control edge 20. However, these control valves from the prior art which exhibit fast and precise control cannot, in the failsafe position 25, simultaneously separate the T control port 501 and the P control port 503 from the A control port 502 in order to ensure that the spindle of the injection unit 15 is at a standstill.

This is because, until now, in the prior art, the geometry of the control slide of a control valve, in particular the width of the piston shoulders 31, 32, 33, 34 and thus the length of the control edges 20, 21, 22, 23, have no longer been able to be changed after the production of the valve and during operation. This means that, in the failsafe position 25 in the failsafe situation, in valves that exhibit good controllability, only a separation of the P control port 503 from the A control port 502 is achieved, as shown in FIGS. 3, 4 and 5, rather than the desired simultaneous separation of the A control port 502 from the P and T control ports 503, 501.

In order that, during operation, the width of the piston shoulder of the control slide 4 nevertheless behaves as if it can be increased in size and decreased in size during operation, FIGS. 6 to 14 show switchable control edges according to the disclosure. FIGS. 6 and 7 in conjunction with FIG. 8 schematically show how the width of the piston shoulders and thus the length of the A-T and P-A control edges can be switched between overlap and zero overlap.

In FIG. 6, the control valve is an active control situation. For this purpose, the first control slide 400, as shown in FIG. 6, comprises an axial bore 40 having a second control slide 41 and at least a first and a second transverse bore 46, 47 in the first and second piston shoulders 31, 32 of the first control slide 400. In addition to a first control edge 45 (A-T1) and a third control edge 44 (P-A), a second control edge 42, 43 (A-T2) is formed. The first and third control edges 45, 44 correspond to the A-T and P-A control edges 21, 22 (as described with reference to FIGS. 3, 4 and 5). The second control slide 41 comprises a first piston shoulder 411 and a second piston shoulder 412 and controls a flow or a flow path through the transverse bores 46, 47 and the axial bore 40. The second control edge 42, 43 (A-T2) and the third control edge 44 (P-A) simultaneously exhibit a zero overlap, as shown by P8 and P11 in FIG. 6, such that precise and fast control by means of the second control slide in the opened position, as shown in FIG. 6, is possible. The first control edge 45 (A-T1) is situated, in FIG. 6, in a position of overlap, P10 in FIG. 6. Furthermore, FIG. 6 shows that the second control edge 42, 43 (A-T2) and third control edge 44 (P-A) together exhibit a relatively small relative overlap, in this case even a very small relative overlap, see P9 in FIG. 6. This has the effect that, as shown in FIG. 8 at the location P8, P11, P9, the characteristic curve 443 of the third control edge and the characteristic curve 452 shown using dashed lines converge on the x axis at a positive control stroke S, such that, depending on the movement of the first control slide 400 to the left or to the right in FIG. 6 (see the arrow symbols), a volume flow immediately passes either between the T and A control ports 501, 502 or between the P and A control ports 503, 502. The volume flow between the T and A control ports 501, 502 passes via the transverse bores 46, 47 and the axial bore 40 when the first control edge 45 (A-T1) is in a position of overlap. Fast and precise control is thus nevertheless possible. By contrast to the prior art, the control occurs not immediately via the A-T control edge, which in FIG. 6 would correspond to the first control edge 45 (A-T1) of the disclosure, but via the second control edge 42, 43 (A-T2), which is not known in the prior art.

The control slide 400 in FIG. 7 is in a failsafe position in a failsafe situation. The second control slide 41 is closed, because the first piston shoulder 411 of the second control slide 41 prevents a flow via the transverse bore 46, P12 in FIGS. 7 and 8.

Thus, the second control edge 42, 43 (A-T2) is in a position of overlap, and no flow occurs between the T and A control ports 501 via the transverse bores 46, 47 and the axial bore 40. The first control edge 45 (A-T1) and third control edge 44 (P-A) also exhibit an overlap in the failsafe position, P13 and P14 in FIG. 7. It is thus ensured that, in the failsafe position 25 (see FIG. 8), no volume flow can pass between the T and A control ports 501, 502 and the P and A control ports 503, 502. There is no flow path via the transverse bores 46, 47 and axial bore 40, and also no direct flow path from the A control port 502 to the T control port 501.

FIG. 8 shows a volume flow-signal function of the control edges from FIGS. 6 and 7 according to the disclosure. The x axis shows the control slide stroke S of the first control slide 400 according to the disclosure. The failsafe position 25 passes through the origin and coincides with the y axis. FIG. 8 shows two cases of a characteristic curve profile of the volume flow between A control port 502 and T control port 501.

In the first case, during active control with the second control slide 41 open and the second and third control edges 42, 43; 44 (A-T2; P-A) open, fast and precise control of the volume flow via the second control edge 42, 43 (A-T2) and third control edge 44 (P-A) is possible. If the first control slide 400 is deflected to the right in the valve body 1 proceeding from FIG. 6, the volume flow between the T control port 501 and A control port 502 increases, as shown by the characteristic curve 452 in FIG. 8, by virtue of a flow path being formed via the second control edge 42, 43 (A-T2) and the transverse bores 46, 47 and axial bore 40. Beyond a certain further deflection to the right, the characteristic curve 452 rises no further, because the maximum flow via the second control edge 42, 43 is limited owing to the diameter of the transverse bores 46, 47 and axial bore 40. However, at P16 in FIG. 8, the first control edge 45 (A-T1) opens, and an additional flow path is between the T and A control ports 501, 502 is formed; see the characteristic curve 451. In the case of a deflection of the first control slide 400 to the left in FIG. 6, that is to say to the right proceeding from P8, P11, P9 in FIG. 8, a flow path opens between the P and A control ports 503, 502, whilst at the same time the flow path between the T and A control ports 501, 502 is closed, as shown by the characteristic curve 443. Fast and precise control of the volume flow between the T, A and P control ports 501, 502, 503 is thus possible. The behavior of the characteristic curves 451 with 452 and the characteristic curve 443 thus corresponds to the behavior of the characteristic curves 201 and 211 from the prior art from FIGS. 3 and 4.

In the second case, in the failsafe situation with the failsafe position 25, the second control slide 41 is closed, as already described with reference to FIG. 7. There is therefore no flow path between the T and A control ports 501, 502 via the second control edge 42, 43 (A-T2), and the characteristic curve 452 does not play a role in the failsafe situation. Accordingly, the volume flow is approximately zero (aside from gap leakages); see P12 in FIG. 8. In the failsafe position 25, the first and third control edges 45, 44 exhibit an overlap, as is symbolically illustrated by the regions P13, P14 in FIGS. 7 and 8. Thus, in the failsafe position in the failsafe situation, a flow path from the A control port 502 to the T control port 501 is shut off by virtue of the first control edge 45 (A-T1) exhibiting a sufficiently large overlap. At the same time, the third control edge 44 (P-A) also exhibits an overlap. It can thus be ensured that a spindle, for example of an injection unit 15, is at a standstill.

FIG. 9 shows an inner bore system in a control slide 400 according to the disclosure. The inner bore system allows a flow between the T and A control ports 501, 502 via an axial bore 40, and forms a second control edge 42, 43 (A-T2) between the T and A control ports 501, 502. Said inner bore system comprises the axial bore 40, a second control slide 41 which controls the flow between the control ports A and T via the second control edge 42, 43 (A-T2) in combination with the first control slide 400, and leakage relief bores 51, 52.

FIG. 9 shows the control valve according to the disclosure in the failsafe position 25 in the failsafe situation (see FIG. 8) with deactivated failsafe valves. Here, a first control edge 45 (A-T1 control edge) and a third control edge 44 (P-A control edge) are configured to simultaneously exhibit an overlap. FIG. 9 illustrates that, in the failsafe situation, the A-T1 and P-A control edges 45, 44 exhibit extensive overlap. This is possible in particular because the second control slide 41 has been brought into a position such that the flow path between the T and A control ports 501, 502 via the second control edge 42, 43 (A-T2) has been shut off owing to the first piston shoulder 411 of the second control slide 41. Thus, in the failsafe position in the failsafe situation, a flow path from the A control port 502 to the T control port 501 is shut off by virtue of the A-T1 control edge 45 exhibiting a sufficiently large overlap. At the same time, the third control edge 44 (P-A) also exhibits an overlap. It can thus be ensured that a spindle, for example of an injection unit 15, is at a standstill.

At the same time, the second control slide 41 in the axial bore 40 controls the A-T2 control edge 42, 43 and thus controls a flow between the T and A control ports 501, 502. In FIG. 9, the second control slide 41 has been brought into a position such that the left-hand piston shoulder 411 of the second control slide 41 shuts off the first transverse bore 46. Therefore, no exchange is possible between the T and A control ports 501, 502 via the axial bore 40 and the second control edge 42, 43 (A-T2).

In FIG. 10, no failsafe situation has arisen, and the control valve according to the disclosure is in normal operation. The illustration shows a position of the piston shoulder of the first control slide 400 in which the third control edge 44 (P-A) and the second control edge 42, 43 (A-T2) are just situated at the opening point in order to control the volume flow/pressure between the T and A control ports 501, 502 and P and A control ports 503, 502. That is to say, in FIG. 10, as already described with reference to FIG. 6, the second control slide 41 is situated in an opened position. A further movement of the first control slide 400 in the valve body 1 to the left into a positive end position has the effect that fluid flows from the P control port 503 via the third control edge 45 (P-A) to a consumer connected to the A control port 502, for example the injection unit 15, and the pressure there rises. An opposite movement of the first control slide 400 to the right into a negative end position causes fluid to flow out of the consumer and thus leads to a decrease of the pressure, because the second control slide 41 has been brought into a position such that the second control edge 42, 43 (A-T2) is opened owing to the movement of the first control slide 400 to the right, and a flow path is thus created between the T and A control ports 501, 502; this is the characteristic curve behavior from FIG. 6 and FIG. 8.

Thus, viewed from the outside, for a viewer without knowledge of the second control slide 41 and of the second control edge (A-T2 control edge), the first control slide 400 behaves as if the width of the piston shoulder 32, that is to say the length of the first control edge 45 (in the prior art), were variable. Therefore, for this viewer, the width of the piston shoulder 32 of the first control slide 400 is switchable even after the production process, by virtue of the fact that one of the two states according to the disclosure of FIGS. 6 and 7 can be assumed. With the control slide 4 from the prior art from FIGS. 1 to 5, this is not possible, as has already been discussed with reference to FIGS. 3 to 5.

FIG. 10 shows a control valve according to the disclosure during normal operation of the A-T2 and P-A control edges 42, 43, 44. The second control slide 41 is in an opened position with overlapping control edges 42, 43, that is to say the second control slide 41 has been brought into a position such that a flow path between the T and A control ports 501, 502 via the axial bore 40 would be possible if the second control edge 42, 43 is opened up by movement of the first control slide 400. This moment is shown on the characteristic curves 452 and 443 at the point P8, P11 and P9 on the x axis in FIG. 8. When complete opening of the second control edge 42, 43 (A-T2) is achieved, the flow path via the second control edge 42, 43 (A-T2) is limited at the maximum flow rate, which means that, even when the second control edge 42, 43 (A-T2) is opened to a maximum extent, the flow rate is limited owing to the size of the diameter of the axial bore 40 and of the first transverse bore 46. Therefore, beyond a certain stroke S of the first control slide 400 to the right, the flow path via the first control edge 45 (A-T1) is additionally opened up. This is shown in FIG. 8 by the characteristic curves 451 and 452 at the point P10 and P15 on the x axis.

FIG. 11 shows a control valve according to the disclosure during normal operation of the first control edge 45 (A-T1) and control edge 23 (P-B). In combination with FIG. 8, in particular the characteristic curves 451 and 231, it is shown that the first control slide 400 has been moved to the right in the valve body 1 into a maximum negative end position, wherein the third control edge 44 has been closed and the second control slide 41 is in a closed position. That is to say, a flow between the T and A control ports 501, 502 via the axial bore 40 is blocked. Instead, FIG. 11 shows that a direct flow path between the T and A control ports 501, 502 is created by virtue of the first control edge 45 (A-T1 control edge) being in an open position and the second control edge 42, 43 (A-T2 control edge) being closed by the second piston shoulder 412 of the second control slide 40. The corresponding volume flow-characteristic curve is schematically illustrated in FIG. 8 at the point of control slide stroke S=−100% and characteristic curves 451 and 231.

Thus, during normal operation, when the second control slide is open, the relatively small overlap between the second control edge 42, 43 (A-T2) and third control edge 44 (P-A) is realized and leads to fast and precise controllability of the volume flow/pressure at the A control port 502, because even in the case of a small deflection of the first control slide, a volume flow arises between the control ports T-A or P-A depending on the direction of action.

At the same time, as illustrated in FIG. 12, the first control slide 400 according to the disclosure can be moved to the left into a positive end position with control slide stroke S=+100%, and can thus, via the third control edge 44 (P-A) and fifth control edge 22 (BT), control a flow between the P and A control ports 503, 502 and B and T control ports 504, 501 via the B-side T channel 505. A flow between the T and A control ports 501, 502 does not occur, because the second control slide 41 has, in FIG. 12, been brought into a position such that the first piston shoulder 411 keeps the second control edge (A-T2) closed and, despite the second piston shoulder 412 in an opened position, no flow occurs via the axial bore 40 between the T and A control ports 501, 502. Furthermore, owing to the positive end position, the first control edge 45 (A-T1) and second control edge 42, 43 (A-T2) are in a position of overlap of the first control slide 400.

In FIGS. 6 to 14, the piston shoulders 411, 412 of the second control slide 41 according to the disclosure are configured such that the second control slide 41, during the movement into a negative end position of the first control slide 400, for example in FIG. 8, opens up the flow path via the second control edge 42, 43 (A-T2). Depending on technical requirements, the second control slide 41 may open up the flow path via the second control edge 42, 43 by being moved into a positive end position (not shown in the figures).

FIGS. 6 to 14 thus show firstly how, when failsafe valves 2 and 61 are activated, a zero overlap behavior and thus fast and precise controllability are possible owing to a relatively small overlap between the second control edge 42, 43 (A-T2) and third control edge 44 (P-A). Secondly, when failsafe valves are deactivated, that is to say in the failsafe position 25 in the failsafe situation, the leakage can be reduced to a minimum, corresponding to gap leakage, by virtue of the first control edge 45 (A-T1) and third control edge (P-A) 44 exhibiting a sufficiently large overlap (see P12, P13 and P14 in FIG. 7), and it is thus possible to ensure that the spindle, for example of an injection unit 15, which is connected to the disclosed control valve system 100 is at a standstill.

FIG. 13 schematically shows a control valve system 100 according to the disclosure, comprising the control valve in a schematic longitudinal section and comprising a failsafe valve 2, a 3/2 directional failsafe seat valve and a pilot control valve 3. For the sake of simplicity, the valve electronics 11 and the position measuring system 10 are not illustrated here. The valve electronics 11 and the position measuring system 10 are schematically illustrated in FIGS. 16 to 19 by being attached to the right-hand end of the valve body 1.

The valve body 1 according to the disclosure comprises a first control slide 400, which may alternatively also be referred to as main control slide 400. The first control slide 400 is equipped with an axial bore 40, in which a second control slide 41 is mounted. The second control slide 41 is also referred to as inner control slide 41. The second control slide 41 is smaller than the first control slide 400. In particular, the diameter of the second control slide 41 is smaller than the diameter of the first control slide 400, such that the second control slide 41 is accommodated within the axial bore 40.

The valve body 1 in FIG. 13 has, from left to right in longitudinal section, a first control port 501, a second control port 502, a third control port 503, a fourth control port 504 and a B-side T channel 505, which is connected via a connecting passage and/or annular channel to the first control port 501. The first control port 501 is a T control port 501. The B-side T channel 505 thus corresponds to a B-side T control port 501. The second control port 502 is an A control port 502. The third control port 503 is a P control port 503. The fourth control port 504 is a B control port 504.

The first control slide 400 and the valve body 1 form a first control edge 45, also referred to as A-T1 control edge. The first control edge 45 regulates the flow rate through a first flow path between the T control port 501 and A control port 502.

Furthermore, the first control slide 400 and the valve body 1 form a second control edge 42, 43, also referred to as A-T2 control edge. The second control edge 42, 43 regulates the flow rate via an additional flow path between the T control port 501 and the A control port 501. Here, the second control edge 42, 43 (A-T2) and the third control edge 44 (P-A) exhibit a relatively small overlap. The first control edge 45 (A-T1) between the control ports T and A exhibits a sufficiently large overlap. This has the effect that, in the failsafe situation, only a relatively small volume flow passes between the control ports T and A. The volume flow is so small that it corresponds to conventional gas leakage.

The second control edge 42, 43 (A-T2) between the control ports T and A has one or more first transverse bores 46, which are connected to the axial bore 40 of the first control slide and allow a flow. At the inlet and outlet, in each case one notch-like annular channel and/or control window 421, 431 is formed (schematically shown in FIG. 14). This makes it possible, on an application-specific basis, to exactly adapt the second control edge (A-T2) 42, 43 in terms of manufacturing to the third control edge 44 (P-A control edge between the P control port 503 and the A control port 502) by means of the annular channel and/or means of the control window. It is thus ensured that the third control edge 44 (P-A) can exhibit a zero overlap and the second control edge 42, 43 (A-T2) can exhibit a small overlap. The sum of these two overlaps yields a relatively small overlap between the second control edge (A-T2) 42, 43 and the third control edge 44 (P-A). This has also been described with reference to FIGS. 6, 7 and 8.

In the first control slide 400, in the region of the A control port 502, one or more additional second transverse bores 47 are formed, which are also connected to the axial bore 40.

Depending on the position of the actuating piston 48, the second control slide 41 activates and/or deactivates the additional flow path through the transverse bores 46, 47 and axial bore 40 between the T and A control ports 501, 502. By means of the deflection of the first control slide 41 to the left or to the right, the throughflow rate and the pressure are controlled via the second control edge 42, 43 (A-T2).

The second control slide 41 has annular surfaces 491, 492 that are acted on by pressure. Said surfaces are formed both on a first piston shoulder 411 in a front region of the second control slide 41 and on a second piston shoulder 412 in the rear region of the second control slide 41. Said surfaces are hydraulically balanced, and a load pressure via the A control port 502 therefore cannot result in an undesired actuation of the second control slide 41.

Leakage that passes into a rear chamber 50 of the second control slide 41 is discharged to the T control port 501 via an axial relief bore 51 and via the B-side T channel 505. For this purpose, the first control slide 400 has one or more third transverse bores 52 in the region of the B-side T channel 505.

The second control slide 41 has, at its right-hand end pointing toward the rear chamber 50, a slot 53. Said slot 53 allows the leakage to be discharged via the axial leakage relief bore 51, which is formed coaxially as an elongation of the axial bore 40, even in the blocked state.

FIG. 14 shows a detail of the left-hand side of the control valve according to the disclosure from FIG. 17, having the first and second control slide according to the disclosure as already described in FIGS. 6 to 13, corresponds. The control valve is performing active control of the third control edge 44 (P-A) and second control edge 42, 43 (A-T2). The inner system is open, that is to say the second control slide 41 has been brought into a position such that the first and second piston shoulders 411, 412 of the second control slide 41 open up the passage between the T control port 501 and A control port 502 via the second control edge 42, 43 and the bore 40. The failsafe valves 2 and 61 are additionally active.

The actuating piston 48 is held open counter to a compression spring 56 by means of the control pressure pX via the valve 61 attached to the end cap chamber 54 of the end cap 57, said compression spring being supported against the inside of the end cap 57 or against a stop 58 (shown in FIG. 14).

The actuating piston 48 has a left-hand annular surface 60 and a right-hand annular surface 55. In the failsafe situation, a spring chamber 59 and a left-hand annular surface 60 of the actuating piston 48 are relieved of pressure via a second valve 61, illustrated by way of example in the figures as a switchable 3/2 directional failsafe seat valve, such that the compression spring 56 pushes the actuating piston 48 against the second control slide 41.

The spring chamber 59 of the actuating piston 48 is permanently relieved of pressure in the direction of the tank via the T control port 501. To achieve this, the spring chamber 59 is connected to the T control port 501 of the valve body 1 via one and/or a plurality of bores 62. Alternatively, said spring chamber may be relieved of pressure via further bores via a Y relief port 507 and/or via a separate leakage relief port connected to the end cap 57 (not shown in FIG. 14).

The 3/2 directional failsafe seat valve 61 in FIG. 13 is electrically switched simultaneously with the 4/2 directional failsafe valve 2. In the failsafe situation, both failsafe valves are electrically deenergized. The 4/2 directional failsafe valve 2, in the electrically deenergized state of the failsafe valve, connects the left-hand and right-hand control chambers 12, 13 of the first control slide 400 in the valve body 1, and thus produces a hydraulic short circuit. Here, the first control slide 400 is set into a defined failsafe position by means of a large spring 131 in the right-hand control chamber 13. The compression spring 56 pushes the first control slide 400, via the actuating piston 48 and the second control slide 41, into a defined failsafe position, which for example corresponds to the failsafe position 25 in FIG. 8.

The failsafe position in the failsafe situation is characterized by the fact that both the third control edge 44 (P-A) and the first control edge 45 (A-T1) assume a position with a sufficiently large overlap. At the same time, the second control slide 41 closes the first transverse bore(s) 46, such that the second control edge 42, 43 (A-T2) also exhibits a sufficient overlap. The first flow path between the control ports T and A, the second flow path between the control ports P and A and the additional flow path between the control ports T and A are thus shut off.

The shaft diameter 63 of the actuating piston 48, which protrudes into the axial bore 40 of the first control slide 400 and actuates the second control slide 41, has a smaller diameter than the first and second piston shoulders 411, 412 and the axial bore 40 of the second control slide 41. Tolerance-induced axial offsets of the piston bores can thus be compensated for.

At the rear region, in the region of the rear chamber 50, the second control slide 41 has a right-hand stop 64, which in the failsafe situation serves to transmit the spring force of an inner spring 65 to the first control slide 400. This may alternatively also occur via a shoulder in the front region of the second control slide 41, in the region of the end cap 57 (not shown in the figures).

During normal operation with the actuating piston 48 open (that is to say the 3/2 directional seat valve electrically energized), the second control slide 41 is actively held open by pressure pX.

The actuating piston 48 is connected via a connecting element 76 or a coupling element to the second control slide 41. The coupling element may be designed as a threaded rod in order to thus compensate for manufacturing-induced axial and angular offsets between the piston axes of the second control slide 41 and the actuating piston 48. The connecting element as a threaded rod is designed for example in the form of a compensating rod with threads at both ends (not illustrated in FIG. 14).

For this purpose, the actuating piston 48 has an axial bore 77 into which the compensating rod is installed. The compensating rod is locked together with the small, inner control slide (41) by means of a right-hand locknut 66, and together with the actuating piston (48) by means of a left-hand locknut 78. The locknut 78 is hardened, and simultaneously constitutes a mechanical stop.

An O-ring 79 seals off the right-hand control chamber 86 of the end cap chamber 54 with respect to the spring chamber 59 in the end cap 57. The O-ring 79 is seated in a relief groove 84 and is thus secured axially against movement. The seal in FIG. 14 may also be implemented in some other form.

The compensating rod 76 has, at the left-hand end, a hexagonal socket 82 by means of which fine axial adjustment of the small, inner control slide is possible before the locknut 78 is tightened.

The leakage relief bores 51, 52, 62 or the control bores to the 3/2 directional seat valve may optionally be equipped with diaphragms that are screwed and corresponding threads.

The actuating piston 48 and the second control slide 41 are heat-treated (hardened and tempered) and thus exhibit relatively high protection against wear.

The overlap and undercoverage and opening points of the control edges 42, 43, 44, 45 relative to one another may be increased or decreased in size on an application-specific basis.

The second control slide 41 may alternatively be equipped with flow-force-compensating structural measures, such as grooves, cams or bevels.

The geometries of the control edges 42, 43, 44, 45 are alternatively optimally adapted, by means of angles, radii or control windows, to specific applications in order to set corresponding flow characteristics of the T, A, P, B control ports 501, 502, 503, 504.

In the end cap 57, which is attached to the left-hand side of the valve body 1, a thread 67 is formed into which a hardened stop 58 is screwed, said stop serving for protection against wear. The end cap 57 is thus not damaged if the actuating piston 48 abuts against the end stop in an end position. Alternatively, the end cap 57 may be produced entirely or partially from hardened material, or the region 68 in which the actuating piston 48 comes into contact with the end cap 57 may be partially hardened.

The mechanism of the second control slide may alternatively be attached to the right-hand side of the valve body 1 in order to correspondingly configure a B-T1 and/or B-T2 control edge to be switchable instead of the A-T1 and/or A-T2 control edge. Furthermore, a combination is also possible in which the second control slide 41 is lengthened within the first control slide 400 such that the first and/or second control edge (A-T1, A-T2) and at the same time also a B-T1 and/or B-T2 control edge are configured to be switchable. The leakage relief bores 51, 52, 62 would be adapted accordingly.

Furthermore, the actuating piston 48 may alternatively be activated and actuated by pressure pX via a 4/2 directional (not illustrated). If the actuating piston 48 is activated externally by pressure pX and a 4/2 directional seat valve, the opening and closing can be performed actively by means of pressure.

The second control edge 42, 43 (A-T2 control edge) can, in the control slide 400, be finely adjusted to the particular application by means of control windows (for example hard-milled, eroded) or alternatively by means of an encircling notch (hard-turned, ground).

FIG. 15 shows an alternative disclosure in which the axial leakage relief bore 51 of the first control slide 400 can open into a control slot 69 and/or an encircling notch 70 on the fourth piston shoulder 34 of the first control slide 400, which connects the axial leakage relief bore 51 to a Y relief port 507 of the valve body 1. For this purpose, the control slot 69 is connected via a fourth transverse bore 73 to the axial leakage relief bore 51, and a further transverse bore 74 to the Y channel 72 is formed in the valve body 1. The leakage from the main control slide 400 can thus also be discharged to Y.

Alternatively, an additional compression spring may be mounted in the left-hand end cap/control chamber 54, 12 between end cap 57 and first control slide 400 (not shown in the figures).

A position measuring system or a proximity switch may be mounted at the actuating piston 48 in order to interrogate the position of the piston and incorporate this into the superordinate machine safety concept.

Alternatively, a supply may be provided to the 3/2 directional seat valve not via the X line but via the P control port 503 of the valve body 1, if this is correspondingly connected via bores to the 3/2 directional seat valve (not illustrated in FIG. 15).

In a further embodiment, the actuating piston may also be designed as a rotary piston. The second control slide is then correspondingly designed as a rotary slide in order to open and close the inner system by performing a rotational movement rather than a longitudinal movement (not illustrated in FIG. 15).

Finally, it is pointed out that the description of the invention and the exemplary embodiments are basically not to be understood as being limiting with regard to a particular physical implementation of the invention. All features discussed and shown in conjunction with individual embodiments of the invention may be provided in different combinations in the subject matter according to the invention in order to implement their advantageous effects simultaneously.

FIGS. 16 to 19 show the control valve system 100 in a schematic illustration together with the valve electronics 11 and a position measuring system 10, which is arranged on the right of the valve body 1. The valve electronics and the position measuring system serve for electronically controlling the first control slide 400. The second control slide 41 is not electronically controlled, but is controlled hydraulically by means of the failsafe valve 61 in interaction with the end cap 57 (attached to the left-hand side of the valve body 1) and actuating piston 48. FIG. 16 shows the control valve system 100 according to the disclosure with deactivated failsafe valves 2, 61 in the failsafe situation, with the first control slide 400 in the central position, and with a second control slide 41 in the closed position. FIG. 17 shows the control valve system 100 according to the disclosure, with activated failsafe valves 2, 61 and active control of the third control edge 44 (P-A) and second control edge 42, 43 (A-T2) with the second control slide 41 in the open position. However, aside from gap leakages, no volume flow passes yet via the second control edge 42, 43 (A-T2) or third control edge 44 (P-A), because these are still just closed and exhibit zero overlap. FIG. 18 also shows a control system 100 according to the disclosure, and shows the control valve system 100 according to the disclosure with activated failsafe valves 2, 61 and active control in a positive maximum end position with control slide stroke S=+100%, in which the main control slide 400 has been moved to the left in the valve body 1 by the valve electronics 11. The third control edge 44 (PA) and the fifth control edge 22 (BT) are thus in a position of undercoverage, and a volume flow passes between the corresponding control ports. FIG. 19 also shows a control system 100 according to the disclosure with activated failsafe valves 2, 61 and a first control slide stroke S=−100% that has been actively brought into a negatively controlled end position. The first control edge 45 (A-T1) is in this case in a position of undercoverage, thus allowing a volume flow between the T and A control ports 501, 502. The fourth control edge 22 (P B) is in a position of undercoverage, and a volume flow passes between the P and B control ports 503, 504. The second control slide 41 is, owing to the position of its second piston shoulder 412, situated in a closed position, and therefore no volume flow passes via the second control edge 42, 43 (A-T2) between the T and A control ports 501, 502.

The scope of protection of the present invention is defined by the claims, and is not limited by the features discussed in the description and/or shown in the figures.

### LIST OF REFERENCE SIGNS

1 Valve body, main stage
2 Failsafe valve, safety valve
3 Pilot control valve
4 Control slide in the prior art
5 Control edge (prior art)
6 Control edge (prior art)
7 Compression springs
8 Adjustable disks, mechanical stop
9 Control ports X, T, A, P, B, Y
10 Position measuring system
11 Valve electronics
12, 13 Control chambers
14 Injection control valve, control valve in the prior art
15 Injection unit
16 Injection cylinder
17 Cylinder chamber/surface
20 P-A control edge
21 A-T control edge
22 B-T control edge
23 P-B control edge
25 Failsafe position
31 First piston shoulder
32 Second piston shoulder
33 Third piston shoulder
34 Fourth piston shoulder
40 Axial bore
41 Second control slide, inner control slide
42, 43 Second control edge, A-T2 control edge
44 Third control edge, P-A control edge
45 First control edge, A-T1 control edge
46 At least one first transverse bore
47 At least one second transverse bore
48 Actuating piston
50 Rear chamber
51 Further axial bore, leakage relief bore
52 At least one third transverse bore, leakage relief bores
53 Slot at the right-hand end of the second control slide
54 End cap chamber
55 Right-hand annular surface of the actuating piston
56 Compression spring
57 End cap
58 Stop
59 Spring chamber
60 Left-hand annular surface of the actuating piston
61 Second valve, 3/2 directional failsafe valve
62 One and/or more bores, leakage relief bores
63 Collar diameter or shaft diameter of the actuating piston
64 Right-hand stop
65 Inner compression spring
66 Right-hand locknut
67 Thread in end cap for stop
68 Region in end cap
69 Control slot for leakage relief to the Y channel
70 Encircling notch
72 Y channel
73 At least one fourth transverse bore to the control slot for leakage relief to the Y channel
74 Further transverse bore
76 Connecting element
77 Axial bore
78 Left-hand locknut
79 O-ring
80 Connection between the two T control ports, tank bridge
82 Hexagonal socket
84 Relief groove
86 Right-hand control chamber of the end cap chamber
100 Control valve system according to the disclosure
131 Large spring in the right-hand control chamber
201 Volume flow-signal characteristic curve of the P-A control edge
211 Volume flow-signal characteristic curve of the A-T control edge
221 Volume flow-signal characteristic curve of the B-T control edge
231 Volume flow-signal characteristic curve of the P-B control edge
411 First piston shoulder of the second control slide
412 Second piston shoulder of the second control slide
400 First control slide
421, 431 Notch-like annular channel, control window
443 Volume flow-signal characteristic curve of third control edge, P-A control edge
451 Volume flow-signal characteristic curve of first control edge, A-T1 control edge
452 Volume flow-signal characteristic curve of second control edge, A-T2 control edge
491 (Annular) surface on the left-hand piston shoulder of the second control slide
492 (Annular) surface on the right-hand piston shoulder of the second control slide
501 T control port, first control port
502 Control port A, second control port
503 Control port P, third control port
504 Control port B, fourth control port
505 B-side T channel
506 Control port X
507 Relief port Y

1. A control valve having a switchable control edge, comprising:
a valve body having a first control slide and at least one first and second control port and at least one control edge, wherein the first control slide has an axial bore, and a second control slide is formed in the axial bore;
an end cap having an actuating piston, wherein the actuating piston is designed to engage into the axial bore, and the actuating piston is designed to move the second control slide in the axial bore;
wherein the valve body and the first control slide form a first control edge and a second control edge; and
wherein a relatively small overlap is formed between the second control edge and a third control edge, and the first control edge exhibits a large overlap, and the second control edge is connected via at least one first transverse bore to the axial bore in the first control slide.

2. The control valve as claimed in claim 1, wherein a connecting element is formed between the actuating piston and the second control slide in order to compensate for axial and angular offsets.

3. (canceled)

4. The control valve as claimed in claim 1, wherein the second control edge has a notch-like annular channel or at least one control window.

5. (canceled)

6. The control valve as claimed in claim 1, wherein the first control slide forms at least a second transverse bore in the port region of a second control port, in particular of an A control port, of the valve body, wherein the at least one second transverse bore is connected to the axial bore.

7. The control valve as claimed in claim 1, wherein the actuating piston (48) is designed to control, by means of the second control slide, a flow path via the second control edge.

8. The control valve as claimed in claim 1, wherein the second control slide has two surfaces of equal area for the purposes of hydraulic compensation.

9. The control valve as claimed in claim 1, wherein the axial bore of the first control slide comprises a chamber having an inner compression spring.

10. The control valve as claimed in claim 1, wherein:
an axial relief bore is formed coaxially with respect to the axial bore; and
the first control slide has, in the region of a B-side T channel, at least a third transverse bore which is connected to the axial relief bore and forms a leakage flow path.

11. The control valve as claimed in claim 1, wherein the second control slide forms, on a right-hand end face of the second control valve, a slot for discharging leakage.

12. The control valve as claimed in claim 1, wherein the end cap furthermore comprises:
a valve; and
a spring chamber having a compression spring and a stop.

13. The control valve as claimed in claim 12, wherein the spring chamber is connected to the valve body via a relief bore.

14. A method of using a control valve comprising:
providing a control valve as claimed in claim 1; and
using the control valve as an injection control valve for controlling an injection unit.

15. A control valve system, comprising
a pilot control valve;
a failsafe valve; and
a control valve as claimed in claim 1.

16. The method as claimed in claim 14, wherein the injection unit is an injection molding machine.
